(19) United States
(12) Patent Application Publication
(10) Pub. No.: US 2018/0232672 A1
(43) Pub. Date: Aug. 16, 2018

(54) RESOURCE ALLOCATION INTERFACE FOR INTERACTIVE RESOURCE DISTRIBUTION

(71) Applicant: Bank of America Corporation, Charlotte, NC (US)

(72) Inventors: Tracy Beth Greene, Mooresville, NC (US); Emily Paige Bosin, Charlotte, NC (US); Sean Michael Gutman, Waxhaw, NC (US)

(21) Appl. No.: 15/430,028

(22) Filed: Feb. 10, 2017

(51) Int. Cl. G06Q 10/06; G06F 7/08

(52) U.S. Cl. CPC G06Q 10/0631; G06F 7/08

(57) ABSTRACT

Embodiments of the present invention provide a system for interactive resource distribution via a resource allocation interface. The system is typically configured for extracting a plurality of records associated with a user from an entity server; analyzing the plurality of records and identifying a set of records from the plurality of records requiring an assignment of a class; identifying an online session initiated by the user on a user device; transmitting control signals to the user device to cause the user device to display a subset of records of the set of records and a first set of classes via the resource allocation interface and to prompt the user to assign the subset of records to the set of classes by one or more gaming means; determining that the assignment of the subset of records to the set of classes is complete and providing a first token to the user.

### BACKGROUND

Improper distribution of resources decreases the efficiency of systems providing recommendations about resource utilization. Thus, there exists a need for a system to facilitate proper distribution of resources.

### SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Embodiments of the present invention address the above needs and/or achieve other advantages by providing apparatuses (e.g., a system, a computer program product comprising computer program code stored on a non-transitory computer-readable medium which is readable by a computer, and/or other devices) and computer implemented methods for facilitating interactive distribution of resources, the system comprising a computer apparatus including a processor and a memory; and a module stored in the memory, comprising executable instructions that when executed by the processor cause the processor to extract a plurality of records associated with a user from an entity server; analyze the plurality of records and identify a set of records from the plurality of records requiring an assignment of a class; identify an online session initiated by the user on a user device; transmit control signals to the user device to cause the user device to present a resource allocation interface in response to identifying the online session initiated by the user, wherein the resource allocation interface displays the set of records requiring the assignment of the class, wherein the control signals transmitted from the system to the user device comprise control signals to cause the user device to display a first subset of records of the set of records via the resource allocation interface on the user device, control signals to cause the user device to display a first set of classes associated with the first subset of records via the resource allocation interface on the user device, wherein the first set of classes are determined by analyzing the first subset of records, and control signals to cause the user device to prompt the user to assign the first subset of records to the first set of classes by one or more gaming means, thereby resulting in the assignment of the first subset of records to the first set of classes; receive, from the user device, the assignment; and in response to receiving the assignment, determine that the assignment is complete and provide a first token to the user.

In some embodiments, the module stored in the memory comprises executable instructions that when executed by the processor further causes the processor to identify the assignment of a first record of the first subset of records to at least one first class of the first set of classes; determine a subset of classes associated with the first class; display the subset of classes and the first record via the resource allocation interface on the user device; and prompt the user to assign the first record to the subset of classes by dividing the first record into fractions via the one or more gaming means.

In some embodiments, the division of the first record into fractions is performed automatically based on analyzing the plurality of records.

In some embodiments, the module stored in the memory comprises executable instructions that when executed by the processor further causes the processor to display a second subset of records of the set of records via the resource allocation interface on the user device; display a second set of classes associated with the second subset of records via the resource allocation interface on the user device, wherein the system determines the second set of classes by analyzing the second subset of records; prompt the user to assign the second subset of records to the second set of classes by the one or more gaming means; and determine that the assignment of the second subset of records to the second set of classes is complete and provide a second token to the user.

In some embodiments, the second subset of records are displayed on the user device via the resource allocation interface after receiving an approval from the user.

In some embodiments, the one or more gaming means may comprise at least one of interaction gestures and screen transition gestures.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described some embodiments of the present invention in general terms, reference will now be made to the accompanying drawings, where:

FIG. 1 presents a resource distribution system environment, in accordance with one embodiments of the present invention;

FIG. 2, presents a block diagram illustrating a mobile device of a user illustrated in FIG. 1, in accordance with embodiments of the present invention;

FIG. 3 presents a block diagram illustrating a computing device of a user illustrated in FIG. 1, in accordance with embodiments of the present invention;

FIG. 4 presents a block diagram illustrating the entity system(s) of FIG. 1, in accordance with embodiments of the present invention;

FIG. 5 presents a block diagram illustrating the resource distribution system of FIG. 1, in accordance with embodiments of the present invention;

FIG. 6 presents a process flow for providing a resource allocation interface for interactive distribution of resources, in accordance with embodiments of the present invention; and

FIG. 7 presents a process flow for interactive sub-distribution of resources, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” and “third party system” may include any organization that processes financial transactions including, but not limited to, banks, credit unions, savings and loan associations, investment companies, stock brokerages, asset management firms, insurance companies and the like. In accordance with embodiments of the invention, the terms “third party system” and “other third party systems” may include any organizations including, but not limited to, photo identification issuing agencies, network managing organizations, email managing organizations, and/or the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

In accordance with embodiments of the invention, an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity. In accordance with embodiments of the invention, a “class” may be a category that classifies the records associated with a customer to provide a holistic view of utilization resources.

In accordance with embodiments of the invention, a “record” may be a transaction, transfer of funds, transfer of resources, and may refer to any activities or communication between a user and an entity, between an entity and a third party system, activities or communication between multiple entities, communication between technology application and the like. Transfer of resources may refer to a payment, processing of funds, international transfer of funds, purchase of goods or services, a return of goods or services, a payment transaction, a credit transaction, or other interactions involving user's resource or account. In the context of financial institution or a resource entity such as a merchant, a resource transfer may refer to one or more of: a sale of goods and/or services, initiating an automated teller machine (ATM) or online banking session, an account balance inquiry, a rewards transfer, an account money transfer or withdrawal, a user accessing their e-wallet, or any other interaction involving the user and/or the user's device that invokes or is detectable by the financial institution. A resource transfer may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; receiving remittances; loading money onto stored value cards (SVCs) and/or prepaid cards and/or international travel cards; paying salary to employees; donating to charities; and/or the like. Unless specifically limited by the context, a “transaction”, a “transfer of funds”, a “record” may refer to any activity initiated between a user and a resource entity or a third party system, or any combination thereof. Typical financial transactions include point of sale (POS) transactions, automated teller machine (ATM) transactions, person to person (p2p) transfers, internet transactions, online shopping, electronic funds transfers between accounts, transactions with a financial institution teller, personal electronic checks, conducting purchases using loyalty/reward points etc. When discussing the resource transfers or transactions are evaluated it could mean that the transactions has already occurred, is in the process of occurring or being processed, or it has yet to be processed/posted by one or more financial institutions.

In accordance with embodiments of the invention, a “token” may be a coin, coupon, emblem, ticket, rebate, or any other reward (hereinafter referred to as a “token”). The token may be associated with an immediate reward or coupon associated with a merchant and/or a managing entity. Additionally or alternatively, the token may be associated with a mobile or online game or an online class, tutorial, or other application. For example, the user may have increased purchasing power, improved status levels, additional gaming content, and the like in a mobile game.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

Many of the embodiments and example embodiments thereof described herein are directed towards providing a resource distribution system to facilitate interactive distribution of resources via a resource allocation interface. The resource distribution system identifies a set of records associated with a user which require assignment of a class and displays the set of records and a set of classes associated with the set of records to the user via the resource allocation interface on the user device. The system prompts the user to assign each of the set of records to at least one class of the set of classes and upon completion of assignment of the set of records, the system provides a token to the user. By analyzing the assignment of the set of records, the system provides a holistic view of utilization of resources associated with the user.

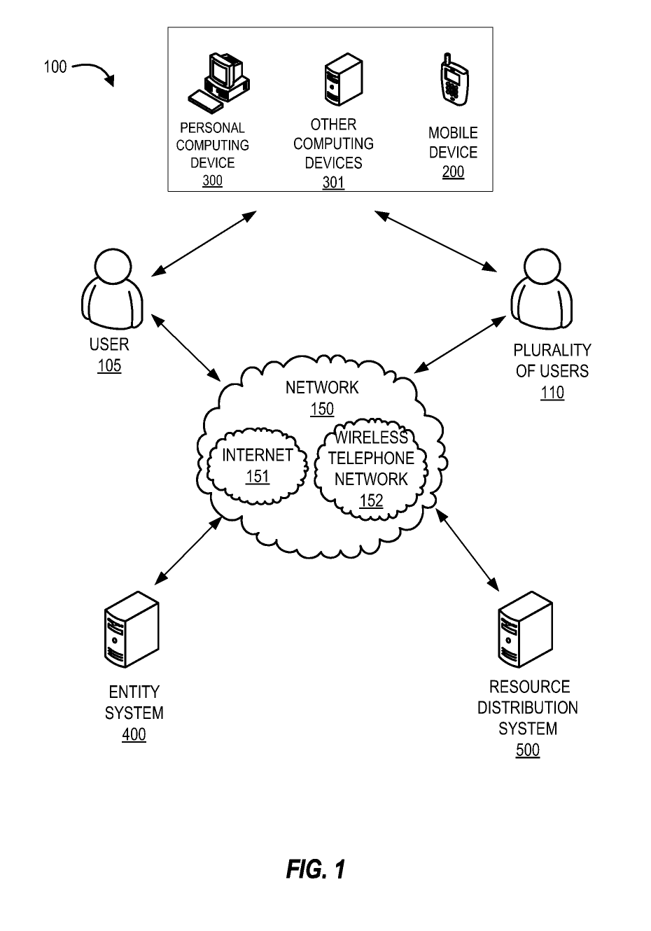

FIG. 1 provides a block diagram illustrating an environment 100 for a resource distribution system. As depicted in the embodiment of FIG. 1, the operating environment 100 may include a resource distribution system 500 interacting with an entity system 400, a user 105, a plurality of users 110, using a network 150. In some embodiments, the resource distribution system 500 may be maintained by the entity. In some embodiments, the resource distribution system 500 may be owned by the entity and maintained by a third party. In some embodiments, the resource distribution system 500 may be a part of the entity system 400. In some embodiments, the user 105 and plurality of users 110 may be customers of the entity. In some embodiments, the system environment may include other third party systems and other entity systems. In some embodiments, the resource distribution system 500 may interact with a plurality of users associated with the entity or a third party.

The environment 100 also may include a plurality of user devices. The user devices may include any machine, apparatus, system or the like that may be connected to and communicate with other devices over a network 150. At least one of the devices may include a personal computing device 300, other computing devices 301, and a mobile device 200 for use by the user 105, plurality of users 110. The computing devices 301 may be any device that employs a processor and memory and can perform computing functions, such as a personal computing device 300 or a mobile device 200, that may be connected to or access the network 150. The personal computing device 300 may include a personal computer such as a desktop computer, laptop computer, tablet or any type of personal computing device that may be connected to a network by landline or wireless access such as wireless local area network (WLAN) such as Wi-Fi based on the Institute of Electrical and Electronics Engineers' (IEEE) 802.11 standards, Bluetooth short-wavelength UHF radio waves in the ISM band from 2.4 to 2.485 GHz or other wireless access technology. As used herein, the mobile device 200 may include any mobile communication device, such as a cellular telecommunications device (i.e., a cell phone or mobile phone), personal digital assistant (PDA), a mobile Internet accessing device, tablet computer, or other mobile device. A mobile device may connect to the network by a cellular telecommunications network or by Wi-Fi, Bluetooth or other access technology.

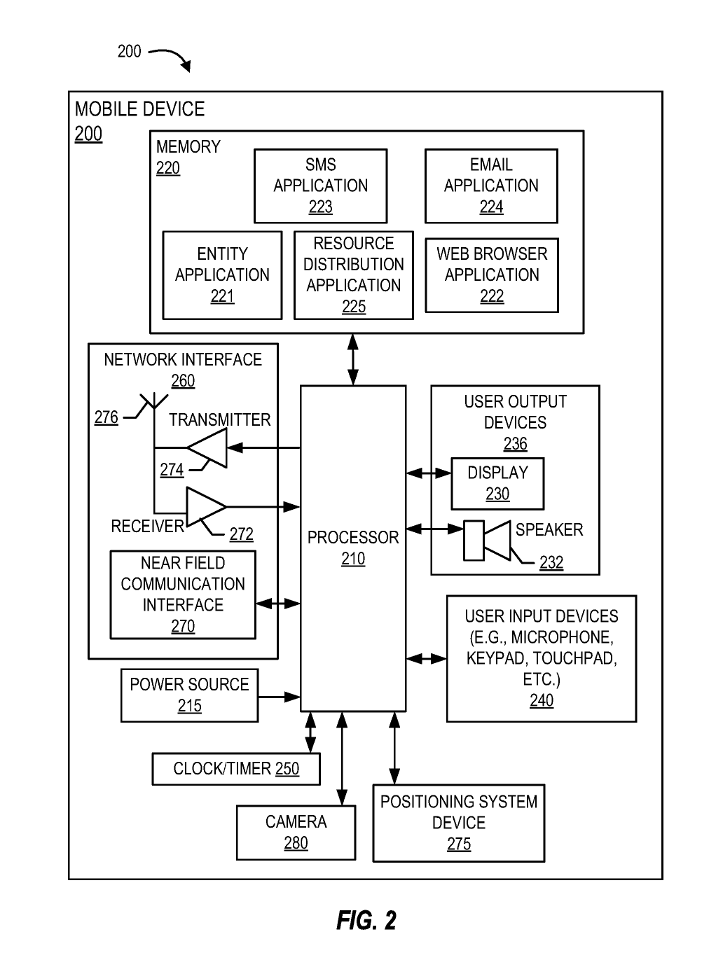

FIG. 2 provides a block diagram illustrating a user's mobile device 200 of FIG. 1 in more detail, in accordance with embodiments of the invention. In one embodiment of the invention, the mobile device 200 is a mobile telephone. However, it should be understood that a mobile telephone and the embodiment of the mobile device 200 shown in FIG. 2 are merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, tablets, mobile televisions, gaming devices, laptop computers, cameras, video recorders, audio/video player, radio, Global Positioning Systems (GPS) devices, or any combination of the aforementioned.

Some embodiments of the mobile device 200 include a processor 210 communicably coupled to such devices as a memory 220, user output devices 236, user input devices 240, and a network interface 260. The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices. The processor 210, and other processing devices described herein, generally include circuitry for implementing communication and/or logic functions of the associated device. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. The memory device 220 may include other applications such as e-mail application 224 and SMS application 223.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

The network interface 260 may also include a near field communication (NFC) interface 270. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 270 may include a smart card, key card, proximity card, Bluetooth® device, radio frequency identification (RFID) tag and/or reader, transmitter, receiver, and/or the like. In some embodiments, the NFC interface 270 communicates information via radio, infrared (IR), and/or optical transmissions. In some embodiments, the NFC interface 270 is configured to operate as an NFC transmitter and/or as an NFC receiver (e.g., an NFC reader). Also, it will be understood that the NFC interface 270 may be embedded, built, carried, and/or otherwise supported in and/or on the mobile device 200. In some embodiments, the NFC interface 270 is not supported in and/or on the mobile device 200, but the NFC interface 270 is otherwise operatively connected to the mobile device 200 (e.g., where the NFC interface 270 is a peripheral device plugged into the mobile device 200). Other apparatuses having NFC interfaces mentioned herein may be configured similarly. In some embodiments, the NFC interface 270 of the mobile device 200 is configured to contactlessly and/or wirelessly communicate information to and/or from a corresponding NFC interface of another apparatus (e.g., an automated teller machine (ATM) or another mobile or computing device).

As described above, the mobile device 200 has a user interface that may be made up of user output devices 236 and/or user input devices 240. The user output devices 236 include a display 230 (e.g., a liquid crystal display or the like) and a speaker 232 or other audio device, which are operatively coupled to the processor 210. The user input devices 240, which allow the mobile device 200 to transmit data, may include any of a number of devices allowing the mobile device 200 to transmit data, such as a keypad, keyboard, touch-screen, touchpad, microphone, mouse, joystick, other pointer device, button, soft key, and/or other input device(s). The user interface may also include a camera 280, such as a digital camera.

The mobile device 200 may also include a positioning system device 275 that is configured to be used by a positioning system to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a location to determine that the mobile device 200 is located proximate these known devices.

The memory 220 is operatively coupled to the processor 210. As used herein, “memory” or “memory device” includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which include computer-executable instructions/code executed by the processor 210 to implement the functions of the mobile device 200 and/or one or more of the process/method steps described herein. The memory 220 includes an entity application 221 that may be used to allow communication with an entity system such as the entity system 400 and/or the smart devices to implement the system of the invention. The use of the entity application 221 may facilitate access to the system of the invention by providing log-in systems including user authentication systems, account information, system controls or the like. The memory 220 includes a resource distribution application 225 that may be used to communicate with the resource distribution system 500. The entity application 221 and resource distribution application 225 communicate with the resource distribution system 500 and the entity system 400 to allow the user to set up and/or control the system of the invention. In some embodiments, the entity application 221 is an online banking application. In some embodiments, the entity application 221 and resource distribution application 225 are part of a single application. In some embodiments, wherein the user is a new customer or a first time user of the entity application 221, the entity application prompts the user to install the resource distribution application 225. In some embodiments, when the user installs the entity application 221, the resource distribution application 225 is automatically installed with the entity application 221.

These applications also typically provide a graphical user interface (GUI) on the display 230 that allows the plurality of users 110 to communicate with the mobile device 200, the entity system 400 and/or other devices or systems. The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user authentication information. In embodiments of the present invention, a resource allocation interface is presented on the display 230 to receive input from the user.

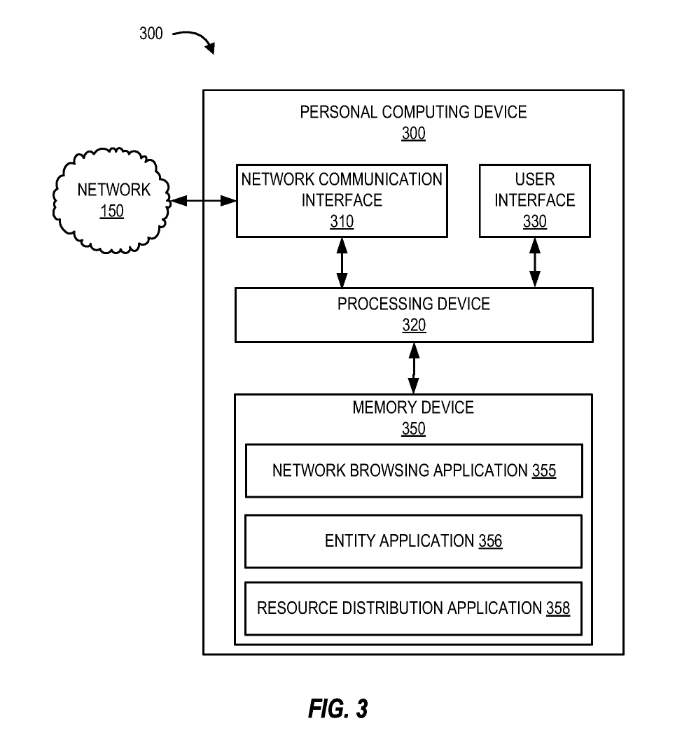

Referring now to FIG. 3, the personal computing device 300 also includes various features, such as a network communication interface 310, a processing device 320, a user interface 330, and a memory device 350. The network communication interface 310 includes a device that allows the personal computing device 300 to communicate over the network 150 (shown in FIG. 1). In one embodiment of the invention, a network browsing application 355 provides for a user to establish network communication with an entity system 400 and resource distribution system 500.

As used herein, a “processor” or “processing device,” such as the processing device 320, generally refers to a device or combination of devices having circuitry used for implementing the communication and/or logic functions of a particular system. For example, a processing device 320 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 320 may further include functionality to operate one or more software programs based on computer-executable program code thereof, which may be stored in memory device 350. As the phrase is used herein, a processor or processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes a plurality of interface devices and/or software that allow a customer to input commands and data to direct the processing device to execute instructions. For example, the user interface 330 presented in FIG. 3 may include a graphical user interface (GUI) or an interface to input computer-executable instructions that direct the processing device 320 to carry out specific functions. The user interface 330 employs certain input and output devices as previously described with reference to FIGS. 1 and 2. These input and output devices may include a display, mouse, keyboard, button, touchpad, touch screen, microphone, speaker, LED, light, joystick, switch, buzzer, bell, and/or other user input/output device for communicating with one or more users. In embodiments of the present invention, the resource allocation interface is presented on the display of the personal computing device 300 to receive input form the user.

As used herein, a “memory” or “memory device” generally refers to a device or combination of devices that store one or more forms of computer-readable media for storing data and/or computer-executable program code/instructions. Computer-readable media is defined in greater detail below. For example, in one embodiment, the memory device 350 includes any computer memory that provides an actual or virtual space to temporarily or permanently store data and/or commands provided to the processing device 320 when it carries out its functions described herein. The memory device 350 may include such applications as a conventional network browsing application 355, an entity application 356, a resource distribution application 358 and/or the like. The entity application 356 may be used to allow communication with an entity system, such as the entity system 400. The resource distribution application 358 may be used to allow communication with the resource distribution system 600 and the entity system 400 to implement one or more actions. The other computing devices 301 as shown in FIG. 1 may include similar system blocks as the personal computing device 300.

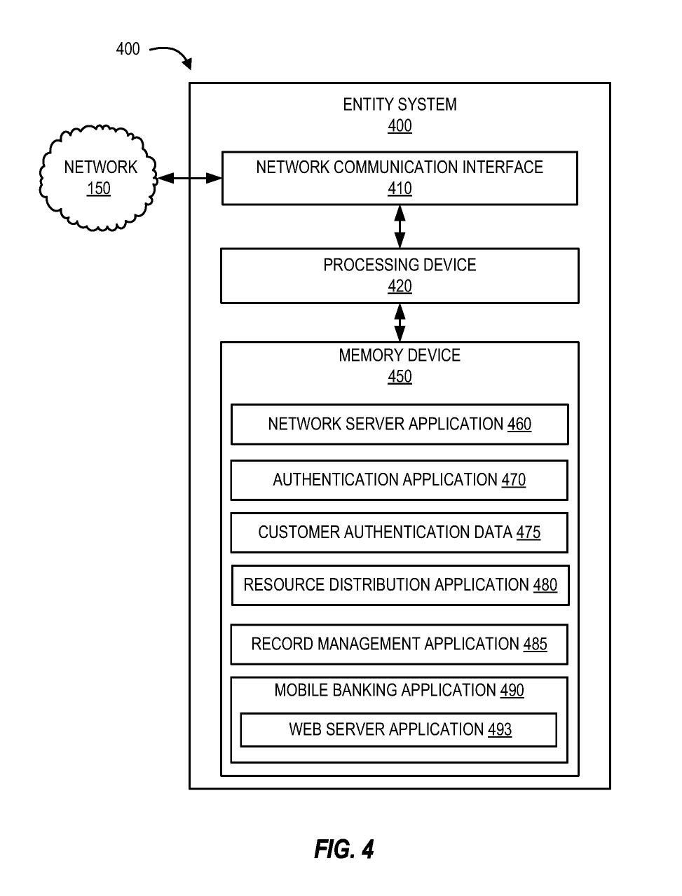

FIG. 4 provides a block diagram illustrating the entity system 400, in greater detail, in accordance with embodiments of the invention. As illustrated in FIG. 4, in one embodiment of the invention, the entity system 400 includes one or more processing devices 420 operatively coupled to a network communication interface 410 and a memory device 450. In certain embodiments, the entity system 400 is operated by an entity, such as a financial institution.

It should be understood that the memory device 450 may include one or more databases or other data structures/repositories. The memory device 450 also includes computer-executable program code that instructs the processing device 420 to operate the network communication interface 410 to perform certain communication functions of the entity system 400 described herein. For example, in one embodiment of the entity system 400, the memory device 450 includes, but is not limited to, a network server application 460, an authentication application 470, customer authentication data 475, a resource distribution application 480, a record management application 485, and a mobile banking application 490 including a mobile web server application 493, and other computer-executable instructions or other data. The computer-executable program code of the network server application 460, the authentication application 470, or the mobile banking application 490 may instruct the processing device 420 to perform certain logic, data-processing, and data-storing functions of the entity system 400 described herein, as well as communication functions of the entity system 400. The mobile banking application 490 communicates with the user devices to facilitate communication between the user and the entity. The memory device 450 may include merchant identifying information and/or the like.

In one embodiment, the network server application 460, the authentication application 470, and the mobile banking application 490 are configured to invoke or use the customer authentication data 475 when authenticating a user to the entity system 400. In some embodiments, the resource distribution application 480 allows communication with the resource distribution system 500 via an automated channel created by the resource distribution system 500 using the network communication interface 410. In one embodiments, the record management application 485 manages a set of records associated with a plurality of users created by the resource distribution system 500.

As used herein, a “communication interface” generally includes a modem, server, transceiver, and/or other device for communicating with other devices on a network. The network communication interface 410 is a communication interface having one or more communication devices configured to communicate with one or more other devices on the network 150, such as the mobile device 200, the personal computing device 300, and/or other computing devices 301. The processing device 420 is configured to use the network communication interface 410 to transmit and/or receive data and/or commands to and/or from the other devices connected to the network 150.

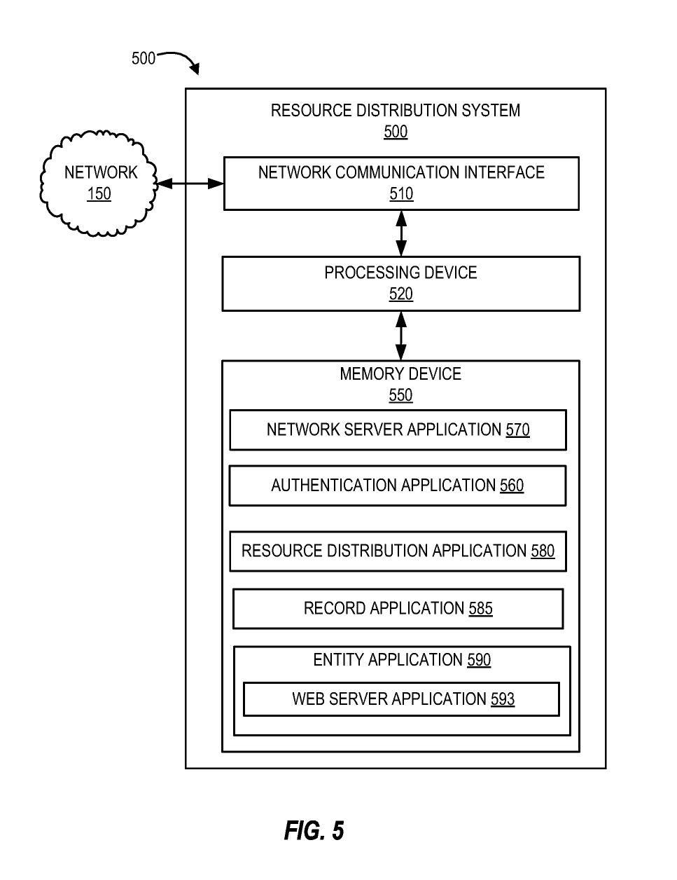

FIG. 5 presents a block diagram illustrating the resource distribution system 500, in accordance with embodiments of the invention. As illustrated in FIG. 4, in one embodiment of the invention, the resource distribution system 500 includes one or more processing devices 520 operatively coupled to a network communication interface 510 and a memory device 550. In certain embodiments, the resource distribution system 500 is operated by an entity, such as a financial institution.

It should be understood that the memory device 550 may include one or more databases or other data structures/repositories. The memory device 550 also includes computer-executable program code that instructs the processing device 520 to operate the network communication interface 510 to perform certain communication functions of the resource distribution system 500 described herein. For example, in one embodiment of the resource distribution system 500, the memory device 550 includes, but is not limited to, a network server application 570, an authentication application 560, a resource distribution application 580, a record application 585, and an entity application 590 including a web server application 593, and other computer-executable instructions or other data. The computer-executable program code of the network server application 570, the authentication application 560, the resource distribution application 580, or the web server application 593 may instruct the processing device 520 to perform certain logic, data-processing, and data-storing functions of the resource distribution system 500 described herein, as well as communication functions of the resource distribution system 500. The entity application 590 communicates with the user devices to facilitate communication between the user and the entity. The record application 585 manages a plurality of records associated with a plurality of users, wherein the plurality of records may be associated with multiple accounts of the plurality of users. The resource distribution application 580 communicates with the entity application 221 or the resource distribution application 225 in the mobile device 200 to facilitate one or more steps in the process flows 600 and 700. The resource distribution application 225 creates the resource allocation interface and displays the resource allocation interface on the mobile device 200 and the personal computing device 300 by communicating with the resource distribution application stored in the memory of the mobile device 200 and the personal computing device 300.

As used herein, a “communication interface” generally includes a modem, server, transceiver, and/or other device for communicating with other devices on a network. The network communication interface 510 is a communication interface having one or more communication devices configured to communicate with one or more other devices on the network 150, such as the mobile device 200, the personal computing device 300, and/or other computing devices 301. The processing device 520 is configured to use the network communication interface 510 to transmit and/or receive data and/or commands to and/or from the other devices connected to the network 150.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

In some embodiments, workflow data or other data such as work assignments, associate or worker profiles and the like may be stored in a non-volatile memory distinct from instructions for executing one or more process steps discussed herein that may be stored in a volatile memory such as a memory directly connected or directly in communication with a processing device executing the instructions. In this regard, some or all the process steps carried out by the processing device may be executed in near-real-time, thereby increasing the efficiency by which the processing device may execute the instructions as compared to a situation where one or more of the instructions are stored and executed from a non-volatile memory, which may require greater access time than a directly connected volatile memory source. In some embodiments, one or more of the instructions are stored in a non-volatile memory and are accessed and temporarily stored (i.e., buffered) in a volatile memory directly connected with the processing device where they are executed by the processing device. Thus, in various embodiments discussed herein, the memory or memory device of a system or device may refer to one or more non-volatile memory devices and/or one or more volatile memory devices.

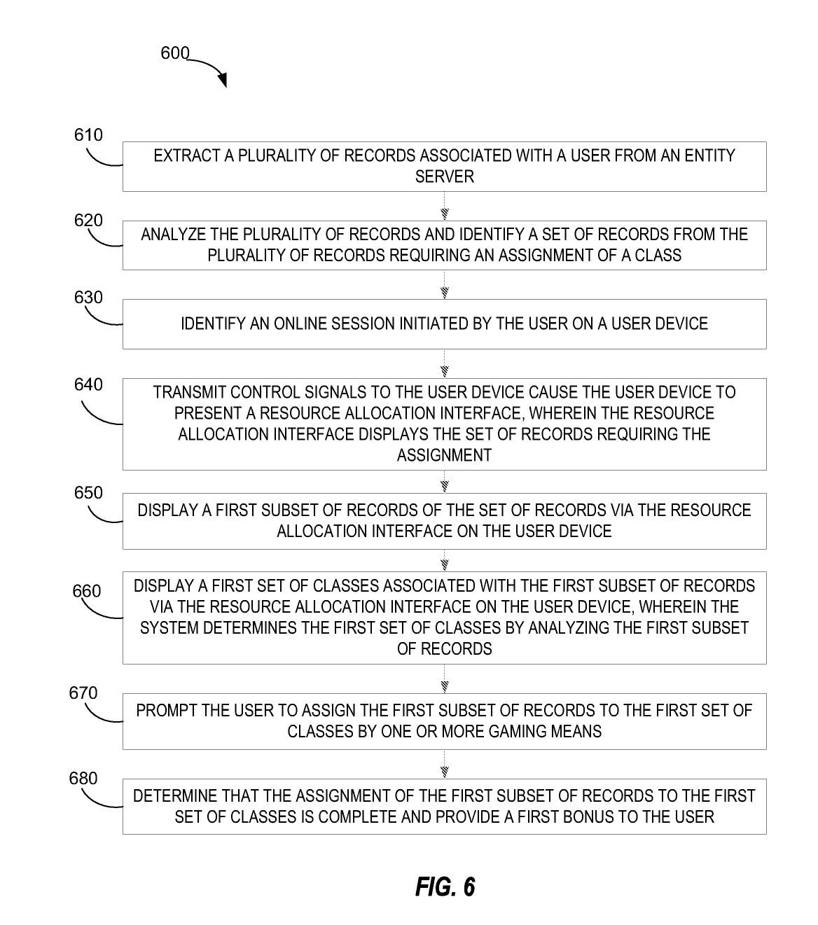

FIG. 6 presents a process flow 600 for providing a resource allocation interface for interactive distribution of resources. As shown in block 610, the system 500 extracts a plurality of records associated with a user from the entity server. In some embodiments, the plurality of records may be transactions related to resource spending associated with the one or more user accounts. For example, the plurality of records may be purchases made by the user using a credit card. In some other embodiments, the plurality of records may be any other records associated with the user.

Next as shown in block 620, the system 500 analyzes the plurality of records and identify a set of records from the plurality of records requiring an assignment of a class. In one exemplary embodiment, the set of records may be transactions associated with an account of the user. For example, the system 500 analyzes the credit card transactions and identifies the set of transactions which require assignment of a class. In some embodiments, the class may be a category to differentiate the type of a record, wherein differentiating the record provides a more holistic view of user resource utilization. For example, record A may be associated with a Merchant A who specializes in selling electronic goods and record B may be associated with a Merchant B who specializes in selling household goods and by identifying the type of transaction, the system 500 provides a holistic view of utilization of resources, wherein the holistic view shows that $X.XX of resources is utilized for “class (1)” and $Y.YY of resources is utilized for “class (2)”, and/or the like. In some embodiments, the system 500 or the entity system 400 automatically assigns a class to some records of the plurality of records based on analyzing the information associated with the plurality of records. For example, the entity system 400 or the system 500 receives merchant information or merchant identifying code associated with a Record X and based on the received merchant information the system 500 assigns the Record X to “class (3)”, wherein class (3) may be “auto and transport” category. In some embodiments, the system 500 may not be able to assign a class to the set of records. For example, a Merchant Y associated with a Transaction Y may specialize in selling both electronic and household goods and the system 500 may not be able to categorize the Transaction Y as Merchant Y is associated with class (2) and class (4) based on analyzing the information associated with Merchant Y, wherein class (2) and class (4) are “household” and “electronics” respectively. The system 500 identifies the set of records which are uncategorized from the plurality of records.

As shown in block 630, the system 500 identifies an online session initiated by the user on a user device. For example, the system 500 identifies an online banking session initiated by the user via the resource distribution application or the entity application on the mobile device 200 or the personal computing device 300.

As shown in block 640, the system 500 transmits control signals to the user device to present a resource allocation interface based on identifying the online session initiated by the user, wherein the resource allocation interface displays the set of records requiring the assignment of the class. The resource allocation interface is an interactive interface which allows the user to interact with the system 500 and assign the set of records to set of classes. The resource allocation interface is a graphical user interface.

As shown in block 650, the system 500 displays a first subset of records of the set of records via the resource allocation interface on the user device. For example, the system 500 displays first 5 records of the set of records via the resource allocation interface on the user device. In some embodiments, the system 500 randomly chooses the first subset of records from the set of records. In some embodiments, the system 500 chooses the first subset of records based on record processing dates. In some embodiments, the system 500 displays the first subset of records to the user as a pop-up on the display of the mobile device 200 or the personal computing device 300.

As shown in block 660, the system 500 displays a first set of classes associated with the first subset of records via the resource allocation interface on the user device, wherein the system determines the first set of classes by analyzing the first subset of records. The system 500 analyzes the first subset of records and identifies all the categories associated with the merchants involved with the first subset of records. For example, the first subset of records may be transactions with Merchant A and Merchant C. Merchant A may specialize in selling electronic goods and household goods and Merchant C may specialize in providing personal care services and products. The system identifies that Merchant A is associated with class (2) and class (4), and Merchant C is associated with class (5), wherein class (2), class (4) and class (5) are “household”, “electronics”, and “personal care” respectively. In some embodiments, the user may create and define a new class via the resource allocation interface.

As shown in block 670, the system 500 prompts the user to assign the first subset of records to the first set of classes by one or more gaming means. For example, the system 500 upon displaying the first subset of records and the first set of classes prompts the user to assign a class from the first set of classes to a record from the first subset of records by one or more gaming means, wherein gaming means may be interaction gestures such as tap, drag, drag, press, flick, pinch, spread, and/or the like. In some embodiments, the system 500 defines the interaction gestures. In alternate embodiments, the user defined the interaction gestures. In other embodiments, the user device defines the interaction gestures. In some embodiments, wherein the user is a new customer of the entity or a first time user of the resource distribution application, the system 500 provides a demo training illustrating the assignment of classes. In one embodiment, based on receiving the prompt from the system 500, the user assigns at least one record of the first subset of records to at least one of the first set of classes. For example, wherein the first subset of records comprises three (3) records and the first set of classes has four (4) classes, the user may assign Record (1) to class (2), Record (2) to class (1), and Record (3) to class (4). In some embodiments, the user may assign a single record to multiple classes from the first set of classes. For example, the user may assign Record (1) to class (2), class (3), and class (4). In such an embodiment, the system 500 the resource allocation interface allows the user to divide the Record (1) into percentages by one or more gaming means. For example, the resource allocation interface displays the Record (1) and allows the user to “slice” the record into different parts by using drag interaction gesture, wherein the Record (1) is presented as a circle. In another example, the resource allocation interface presents a scale of percentage under the first record and allows the user to adjust the scale metrics to define divisions of the first record by using drag interaction gesture. In an exemplary embodiment, wherein the system presents three (3) records and four (4) classes to the user, Record (1) may be associated with Merchant A who specializes in selling products belonging to class (2) and class (4). The system 500 allows the user to assign a single record to multiple classes by dividing the first record into different parts. The user may assign 40% of the first record to class (2) and 60% of the first record to class (4) or the user may assign 100% of the first record to class (2) or class (4). In some embodiments, the system 500 automatically divides the first record based on analyzing the plurality of records. For example, the system 500 analyzing history of transactional data and automatically divides the first record. In an exemplary embodiment, the system 500 identifies a recurring transaction and based on the historical data the system 500 divides the first record, wherein the historical data comprises user selection of division of a record similar to the recurring transaction.

In some embodiments, the user assigns a record from the first subset of records to class (7), wherein the class (7) is a “garbage” class. For example, the user assigns a transaction used for a second user and into the garbage class, wherein the second user gives monetary bills corresponding to the transaction amount to the user. In some embodiments, the system 500 automatically assigns a record from the first subset of records to garbage class based on analyzing the plurality of transactions. For example, the system 500 based on identifying that the user has returned the goods purchased from Merchant A, assigns the transactions related to the purchase and return of the goods to garbage class.

In some embodiments, the set of records may be presented in various shapes and sizes. In one exemplary embodiment, the system 500 defines size and shape of a record based on the merchant identifying information associated with the record. In another exemplary embodiment, the system 500 defines size and shape of a record based on an amount associated with the record.

As shown in block 680, the system 500 determines that the assignment of the first subset of records to the first set of classes is complete and provide a first token to the user in response to receiving the assignment of the first subset of records to the first set of classes. The first token may be a monetary token, reward points, coins, tickets, coupon, and/or the like. For example, the system determines that the user has assigned each of the first subset of transactions to at least one class of the first set of classes and provides a monetary token to the user. In some embodiments, the system 500 assigns the first token to the user and upgrades the level of the user profile. For example, when the user assigns the first subset of records to the first set of classes, the system 500 upgrades the user from Level (1) to Level (2). Completion of Level (1) may require assignment of a class for three (3) records to advance to Level (2) and completion of Level (2) may require assignment of a class for five (5) records to advance to Level (3), wherein the type of token provided after completion of each level is different. In some embodiments, the system 500 after determining that the assignment of the first subset of records to the first set of classes is complete, displays a second subset of records of the set of records via the resource allocation interface on the user device. In some embodiments, the system 500 displays second subset of records after receiving an approval from the user. For example, the system 500 may prompt the user to determine whether he would like to continue assigning the second subset of records to at least one class of the second set of classes. Upon receiving an approval from the user, the system 500 displays the second subset of records via the resource allocation interface. In some embodiments, the number of subset of records in each level is set by the system 500. In some embodiments, the number of subset of records in each level is set by the entity system 400.

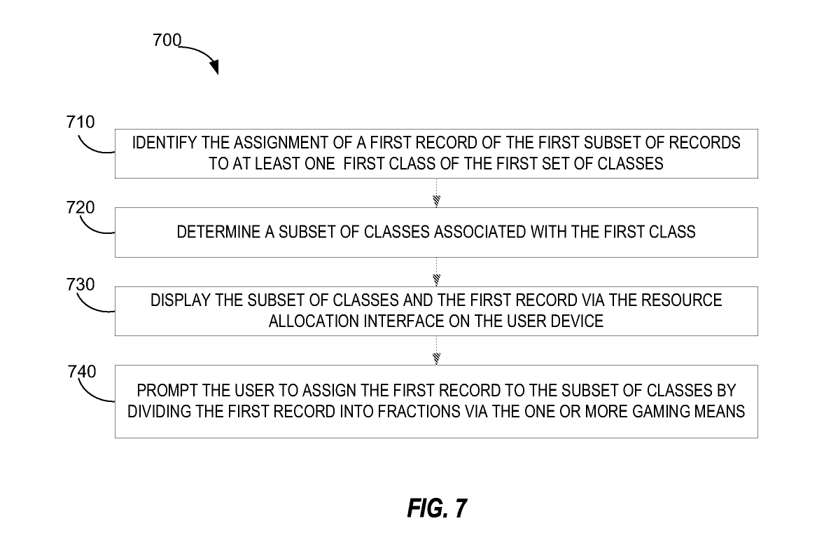

FIG. 7 presents a process flow 700 for sub-distribution of resources. As shown in block 710, the system 500 identifies the assignment of a first record of the first subset of records to at least one first class of the first set of classes. For example, the system identifies that the user assigned “class (6)”, wherein class (6) may be a “miscellaneous” category.

As shown in block 720, the system 500 identifies a subset of classes associated with the first class. In some embodiments, the subset of classes are defined by the system 500 automatically. In some other embodiments, the subset of classes are defined by the user. For example, the user defines subset of classes associated with a “miscellaneous” class. In another example, the user may define a subset of classes under the class “household”, wherein the subset of classes may be “food”, “cleaning”, and/or the like. As shown in block 730, the system 500 displays the subset of classes and the first record via the resource allocation interface on the user device, wherein the system 500 displays the subset of classes only when the user assigns a record to the class having the subset of classes. For example, based on identifying that the user has assigned Record (1) to “household” class, the system 500 displays the subset of classes associated with the class “household.”

As shown in block 740, the system 500 prompts the user to assign the first record to the subset of classes by dividing the first record into fractions via the one or more gaming means. For example, wherein the system displays the subset of classes associated with class “household” based on identifying that the user has assigned Record (1) to class “household”, the user slices 40% of the Record (1) and assigns it to “cleaning” and 60% of the Record (1) to “food.” The system 500 provides an additional tokens to the user based on determining that the user has assigned the first record to the subset of classes.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### Incorporation by Reference

To supplement the present disclosure, this application further incorporates entirely by reference the following commonly assigned patent applications:

| | U.S. patent | | |
|---|---|---|---|
| Docket Number | application Ser. No. | Title | Filed On |
| 7628US1.014033.2952 | To be assigned | TARGETED RESOURCE TOKEN | Concurrently |
| | | GENERATION AND DEPLOYMENT | herewith |
| 7629US1.014033.2953 | To be assigned | THIRD PARTY ACTIVITY | Concurrently |
| | | PERFORMANCE CROSS ENTITY | herewith |
| | | INTEGRATION | |
| 7630US1.014033.2954 | To be assigned | SYSTEM AND METHOD FOR | Concurrently |
| | | LOCATION-BASED | herewith |
| | | TRAFFICKING FOR RESOURCE | |
| | | ACCUMULATION | |
| 7631US1.014033.2955 | To be assigned | CUSTOMIZED INTERACTION | Concurrently |
| | | MANIPULATION AND | herewith |
| | | IMPLEMENTATION FOR | |
| | | RESOURCE STORAGE | |

What is claimed is:

1. A system for interactive resource distribution, wherein the system provides a resource allocation interface and the system comprises:
a computer apparatus including a processor and a memory; and
a module stored in the memory, comprising executable instructions that when executed by the processor cause the processor to:
extract a plurality of records associated with a user from an entity server;
analyze the plurality of records and identify a set of records from the plurality of records requiring an assignment of a class;
identify an online session initiated by the user on a user device;
transmit control signals to the user device to cause the user device to present a resource allocation interface in response to identifying the online session initiated by the user, wherein the resource allocation interface displays the set of records requiring the assignment, wherein the control signals transmitted from the system to the user device comprise:
control signals to cause the user device to display a first subset of records of the set of records via the resource allocation interface on the user device;
control signals to cause the user device to display a first set of classes associated with the first subset of records via the resource allocation interface on the user device, wherein the first set of classes are determined by analyzing the first subset of records; and
control signals to cause the user device to prompt the user to assign the first subset of records to the first set of classes by one or more gaming means, thereby resulting in the assignment of the first subset of records to the first set of classes;
receive, from the user device, the assignment; and
in response to receiving the assignment, determine that the assignment is complete and provide a first token to the user.

2. The system of claim 1, wherein the module stored in the memory comprises executable instructions that when executed by the processor further causes the processor to :
identify the assignment of a first record of the first subset of records to at least one first class of the first set of classes;
determine a subset of classes associated with the first class;
display the subset of classes and the first record via the resource allocation interface on the user device; and
prompt the user to assign the first record to the subset of classes by dividing the first record into fractions via the one or more gaming means.

3. The system of claim 1, wherein the module stored in the memory comprises executable instructions that when executed by the processor further causes the processor to:
display a second subset of records of the set of records via the resource allocation interface on the user device;
display a second set of classes associated with the second subset of records via the resource allocation interface on the user device, wherein the system determines the second set of classes by analyzing the second subset of records;
prompt the user to assign the second subset of records to the second set of classes by the one or more gaming means; and
determine that the assignment of the second subset of records to the second set of classes is complete and provide a second token to the user.

4. The system of claim 3, wherein the second subset of records are displayed on the user device via the resource allocation interface after receiving an approval from the user.

5. The system of claim 1, wherein the one or more gaming means may comprise at least one of interaction gestures and screen transition gestures.

6. The system of claim 2, wherein division of the first record into fractions is performed automatically based on analyzing the plurality of records.

7. A computer program product comprising computer program code stored on a non-transitory computer-readable medium which is readable by a computer, said computer program product is used for interactive resource distribution via a resource allocation interface, said computer program code comprising computer instructions to cause one or more computer processors to perform the operations of:
extracting a plurality of records associated with a user from an entity server;
analyzing the plurality of records and identify a set of records from the plurality of records requiring an assignment of a class;
identifying an online session initiated by the user on a user device;
transmitting control signals to the user device to cause the user device to present a resource allocation interface in response to identifying the online session initiated by the user, wherein the resource allocation interface displays the set of records requiring the assignment, wherein the control signals transmitted from the system to the user device comprise:
control signals to cause the user device to display a first subset of records of the set of records via the resource allocation interface on the user device;
control signals to cause the user device to display a first set of classes associated with the first subset of records via the resource allocation interface on the user device, wherein the first set of classes are determined by analyzing the first subset of records;
control signals to cause the user device to prompt the user to assign the first subset of records to the first set of classes by one or more gaming means thereby resulting in the assignment of the first subset of records to the first set of classes;
receiving, from the user device, the assignment; and
in response to receiving the assignment, determine that the assignment is complete and provide a first token to the user.

8. The computer program product of claim 7, wherein said computer program code comprising computer instructions to cause one or more computer processors to perform the operations of:
identifying the assignment of a first record of the first subset of records to at least one first class of the first set of classes;
determining a subset of classes associated with the first class;
displaying the subset of classes and the first record via the resource allocation interface on the user device; and
prompting the user to assign the first record to the subset of classes by dividing the first record into fractions via the one or more gaming means.

9. The computer program product of claim 7, wherein said computer program code comprising computer instructions to cause one or more computer processors to perform the operations of:
displaying a second subset of records of the set of records via the resource allocation interface on the user device;
displaying a second set of classes associated with the second subset of records via the resource allocation interface on the user device, wherein the system determines the second set of classes by analyzing the second subset of records;
prompting the user to assign the second subset of records to the second set of classes by the one or more gaming means; and
determining that the assignment of the second subset of records to the second set of classes is complete and provide a second token to the user.

10. The computer program product of claim 9, wherein the second subset of records are displayed on the user device via the resource allocation interface after receiving an approval from the user.

11. The computer program product of claim 7, wherein the one or more gaming means may comprise at least one of interaction gestures and screen transition gestures.

12. The computer program product of claim 8, wherein division of the first record into fractions is performed automatically based on analyzing the plurality of records.

13. A computer implemented method for interactive resource distribution, the method comprising:
extracting a plurality of records associated with a user from an entity server;
analyzing the plurality of records and identify a set of records from the plurality of records requiring an assignment of a class;
identifying an online session initiated by the user on a user device;
transmitting control signals to the user device to cause the user device to present a resource allocation interface in response to identifying the online session initiated by the user, wherein the resource allocation interface displays the set of records requiring the assignment, wherein the control signals transmitted from the system to the user device comprise:
control signals to cause the user device to display a first subset of records of the set of records via the resource allocation interface on the user device;
control signals to cause the user device to display a first set of classes associated with the first subset of records via the resource allocation interface on the user device, wherein the first set of classes are determined by analyzing the first subset of records;
control signals to cause the user device to prompt the user to assign the first subset of records to the first set of classes by one or more gaming means thereby resulting in the assignment of the first subset of records to the first set of classes;
receive, from the user device, the assignment; and
in response to receiving the assignment, determine that the assignment is complete and provide a first token to the user.

14. The computer implemented method of claim 13, wherein the method further comprises:
identifying the assignment of a first record of the first subset of records to at least one first class of the first set of classes;
determining a subset of classes associated with the first class;
displaying the subset of classes and the first record via the resource allocation interface on the user device; and
prompting the user to assign the first record to the subset of classes by dividing the first record into fractions via the one or more gaming means.

15. The computer implemented method of claim 13, wherein the method further comprises:
displaying a second subset of records of the set of records via the resource allocation interface on the user device;
displaying a second set of classes associated with the second subset of records via the resource allocation interface on the user device, wherein the system determines the second set of classes by analyzing the second subset of records;
prompting the user to assign the second subset of records to the second set of classes by the one or more gaming means; and
determining that the assignment of the second subset of records to the second set of classes is complete and provide a second token to the user.

16. The computer implemented method of claim 15, wherein the second subset of records are displayed on the user device via the resource allocation interface after receiving an approval from the user.

17. The computer implemented method of claim 13, wherein the one or more gaming means may comprise at least one of interaction gestures and screen transition gestures.

18. The computer implemented method of claim 14, wherein division of the first record into fractions is performed automatically based on analyzing the plurality of records.
